(19) United States
(12) Patent Application Publication
(10) Pub. No.: US 2010/0206705 A1
(43) Pub. Date: Aug. 19, 2010

(54) SWITCH DEVICE

(75) Inventor: Masahiro Yamamoto, Kasugai-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/704,387

(22) Filed: Feb. 11, 2010

(30) Foreign Application Priority Data
Feb. 16, 2009 (JP) 2009-032563

(51) Int. Cl. H01H 13/14

(52) U.S. Cl. 200/341

(57) ABSTRACT

A switch device has a slider that advances and retreats in a front-back direction, a push button that is integrally provided at a front end of the slider, a switch contact whose on and off states are switched according to an operation for pushing down the push button to cause the slider to retreat, a biasing member that biases the slider in an advancing direction in order to return the push button and the slider to a non-manipulated position, a case in which the switch contact, the biasing member, and the slider are assembled, the push button being disposed in an opening at a front end of the case, a front-portion constituent member that is attached to the case while disposed around the push button in the opening, and a coil that is wound around a bobbin formed in an outer circumference of the front-portion constituent member.

### BACKGROUND OF THE INVENTION

1. Technical Field

The present invention relates to a switch device suitable for starting a vehicle engine.

2. Related Art

Recently a type of vehicle, in which a user does not conventionally insert a key in a key cylinder to turn the key, but the user having a proper electronic key starts up an engine only by pressing a push button of an engine starting switch device provided on a driver seat on a condition that the vehicle is equipped with an authentication system such as a so-called immobilizer, has become widespread in vehicles such as a four-wheeled vehicle. Japanese Unexamined Patent Publication No. 10-205183 discloses an automotive key cylinder in which a drain property is considered. In the automotive key cylinder disclosed in Japanese Unexamined Patent Publication No. 10-205183, a drain hole is made in a lower portion on a front-end side of a case, and a liquid (such as rain water) invading in a cylinder head from a key plate hole is drained away from the drainage hole to the outside of the case.

### SUMMARY

There has been proposed that a coil antenna is provided as an emergency antenna in an outer circumferential portion (around the push button) at a front end of the switch device when normal wireless communication for verification cannot be conducted between the electronic key and an antenna of the in-vehicle controller for immobilizer because a battery for the immobilizer electronic key is consumed.

However, when the coil antenna is simply provided in the outer circumferential portion at a front end of the switch device to make the drain hole in a lower portion at the front end of the case of the switch device, possibly a lead constituting the coil antenna can be visually recognized from the drain hole in a state of the single switch device, and it is undesirable from a viewpoint of security.

One or more embodiments of the present invention avoids security degradation caused by visually recognizing the coil from the outside of the switch device while a drain property of the liquid invading from a gap of the outer circumference of the push button is maintained in the switch device in which a coil is disposed around the push button of the front-end portion.

In accordance with one aspect of the present invention, there is provided a switch device including: a slider that advances and retreats in a front-back direction; a push button that is integrally provided at a front end of the slider; a switch contact whose on and off states are switched according to an operation for pushing down the push button to cause the slider to retreat; a biasing member that biases the slider in an advancing direction in order to return the push button and the slider to a non-manipulated position; a case in which the switch contact, the biasing member, and the slider are assembled, the push button being disposed in an opening at a front end of the case; a front-portion constituent member that is attached to the case while disposed around the push button in the opening; and a coil that is wound around a bobbin formed in an outer circumference of the front-portion constituent member, wherein a drain that causes a liquid to flow down to a lower portion on a rear side of the bobbin through an inside of the bobbin is formed in the front-portion constituent member, the liquid invading from a gap between an outer circumference of the push button and the front-portion constituent member, and a drain port that is joined to and communicated with a lower-end opening of the drain with no gap therebetween is formed on a bottom surface side of the case, and at least the coil cannot be visually recognized from the drain port.

In the switch device according to one or more embodiments of the present invention, the coil bobbin is formed in the outer circumference of the front-portion constituent member, the drain that causes the liquid to flow down to the lower portion on the rear side of the bobbin through the inside of the bobbin is formed in the front-portion constituent member, the liquid invading from the gap between the outer circumference of the push button and the front-portion constituent member, the drain port that is joined to and communicated with the lower-end opening of the drain with no gap therebetween is formed on the bottom surface side of the case, and at least the coil cannot be visually recognized from the drain port. Therefore, the security degradation caused by visually recognizing the coil from the outside of the switch device can be avoided while the drain property of the liquid invading from the gap of the outer circumference of the push button is maintained.

In a switch device according to one or more embodiments of the present invention, a circuit board to which the switch contact and the coil are connected is provided in the case, and the circuit board and the switch contact cannot be visually recognized from the drain port. In this case, the security degradation caused by visually recognizing the circuit board and the switch contact from the outside of the switch device can be avoided.

In the switch device according to one or more embodiments of the present invention, the security degradation caused by visually recognizing the coil provided in the outer circumferential portion (around the push button) at the front end of the switch device from the outside of the switch device can be avoided while the drain property of the liquid invading from the gap of the outer circumference of the push button is maintained.

### BRIEF DESCRIPTION OF THE DRAWINGS

FIG. 1A is a front view of a switch device, and FIG. 1B is a sectional view taken along line A-A of FIG. 1A;

FIG. 2A is a sectional view taken along line B-B of the switch device of FIG. 1A, and FIG. 2B is a sectional view taken along line E of the switch device of FIG. 1A;

FIG. 3 is a sectional view taken along line C-C of the switch device (neutral state) of FIG. 1A;

FIG. 4 is a sectional view taken on the line C-C of the switch device (full-stroke state) of FIG. 1A;

FIG. 5 is a sectional view taken along line D-D of the switch device of FIG. 1A;

FIG. 6A is a bottom view of a front-portion constituent member (including a front-face circumferential member), FIG. 6B is a bottom view of the front-portion constituent member, and FIG. 6C is a front view of the front-face circumferential member;

FIGS. 7A and 7B are bottom views of the switch device in which a second case is removed, FIG. 7A illustrates a state in which a lower plate is mounted, FIG. 7B illustrates a state in which the lower plate is not mounted, and FIG. 7C illustrates a configuration example of a contact; and

FIG. 8 is a sectional view taken along line F-F of the switch device of FIG. 1A.

### DETAILED DESCRIPTION

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Hereinafter, a first embodiment of the present invention will be described with reference to the drawings.

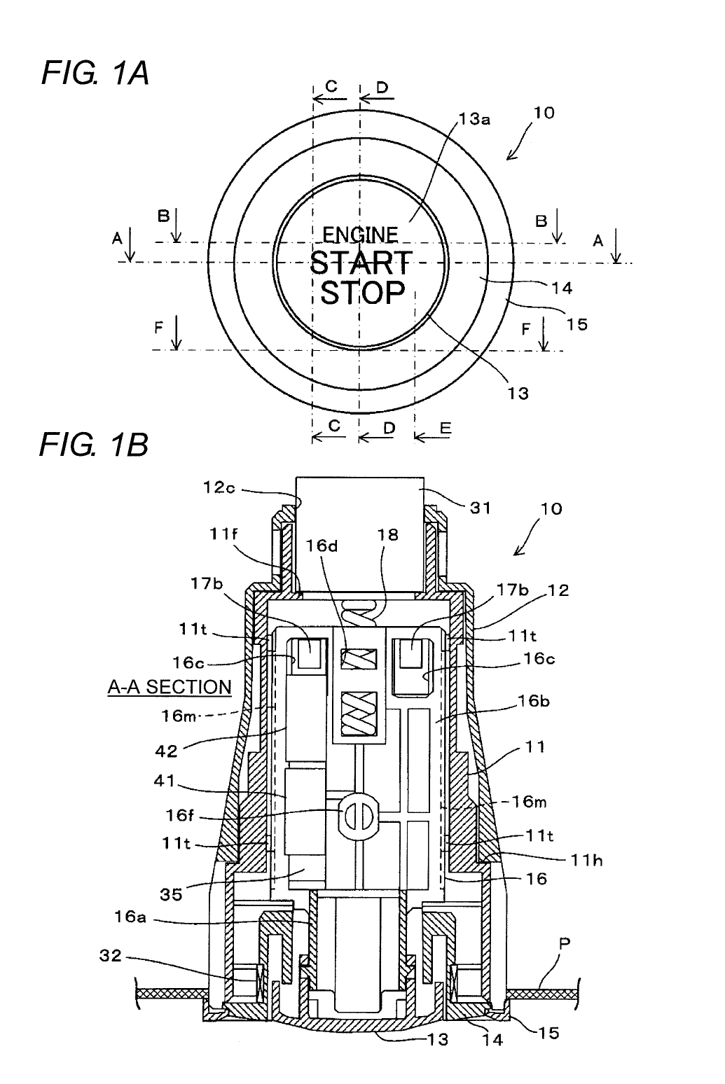

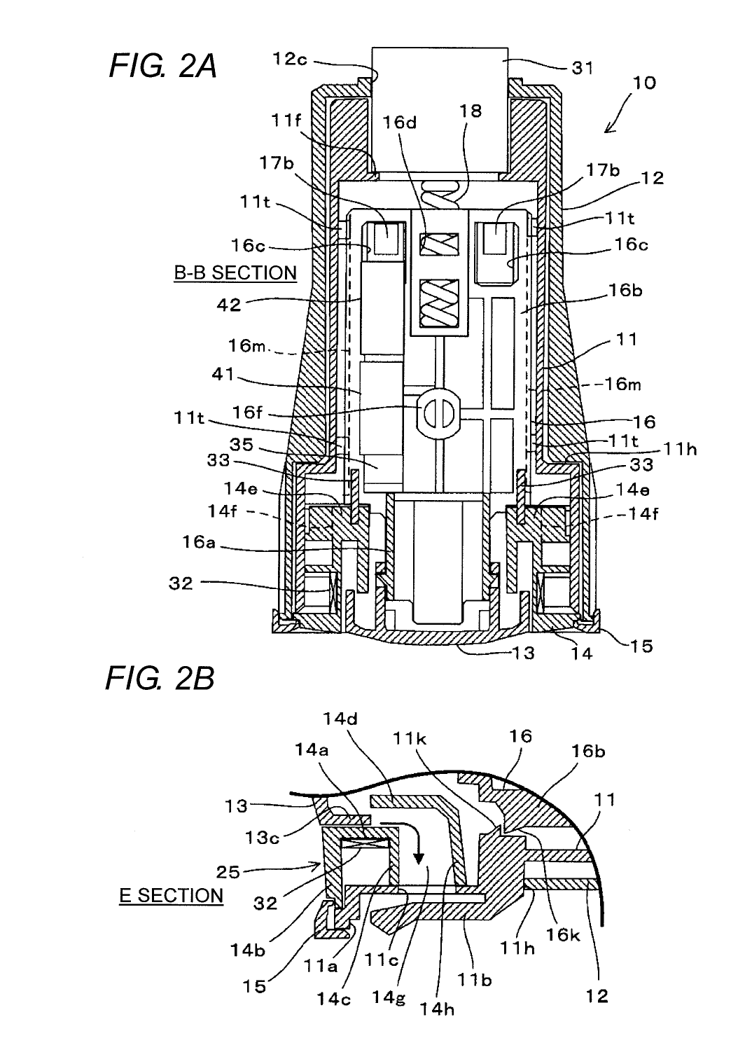

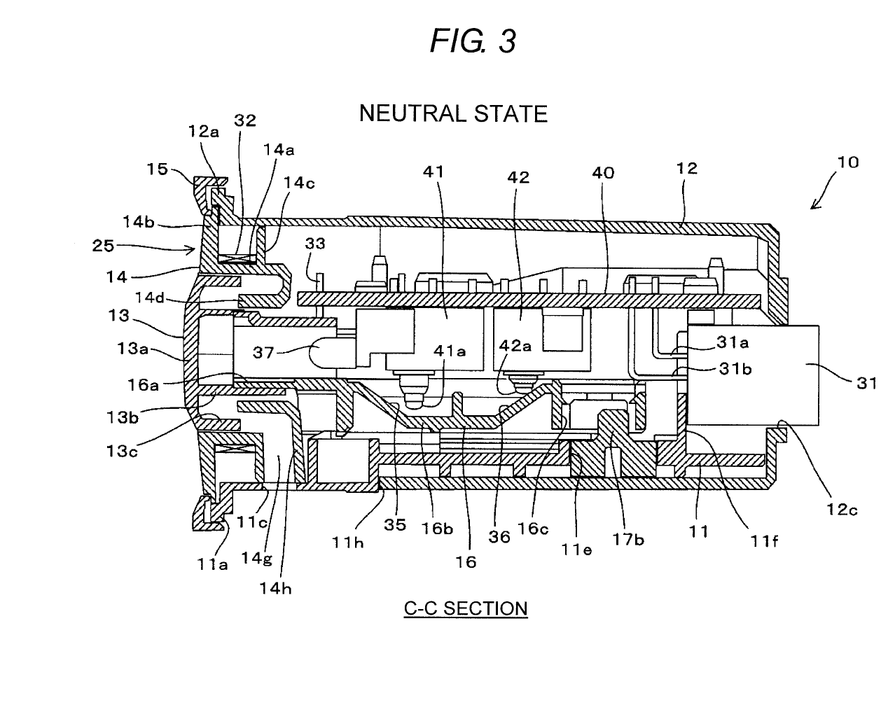

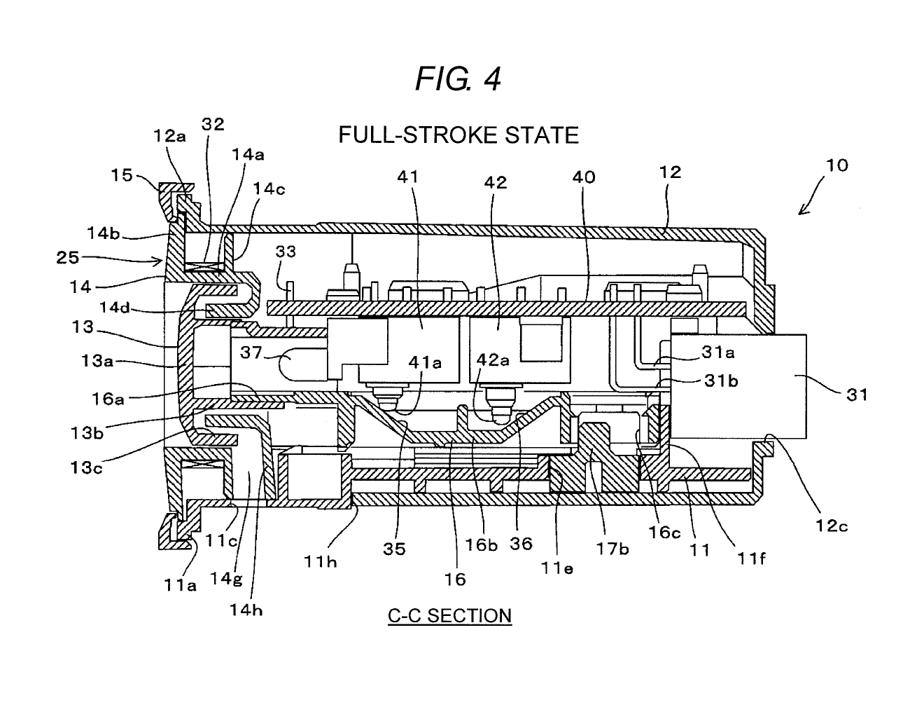

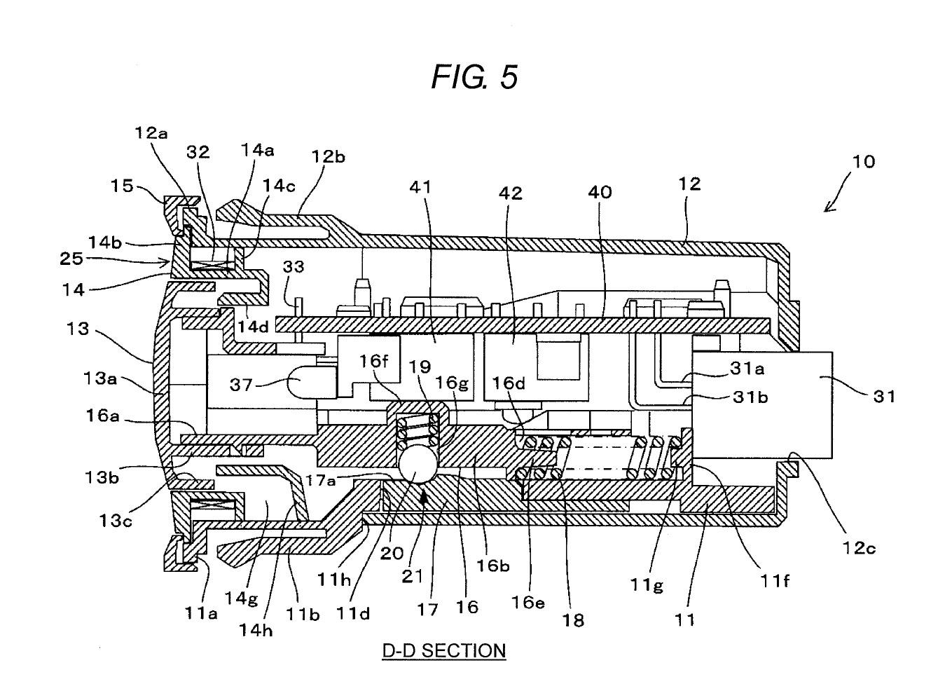

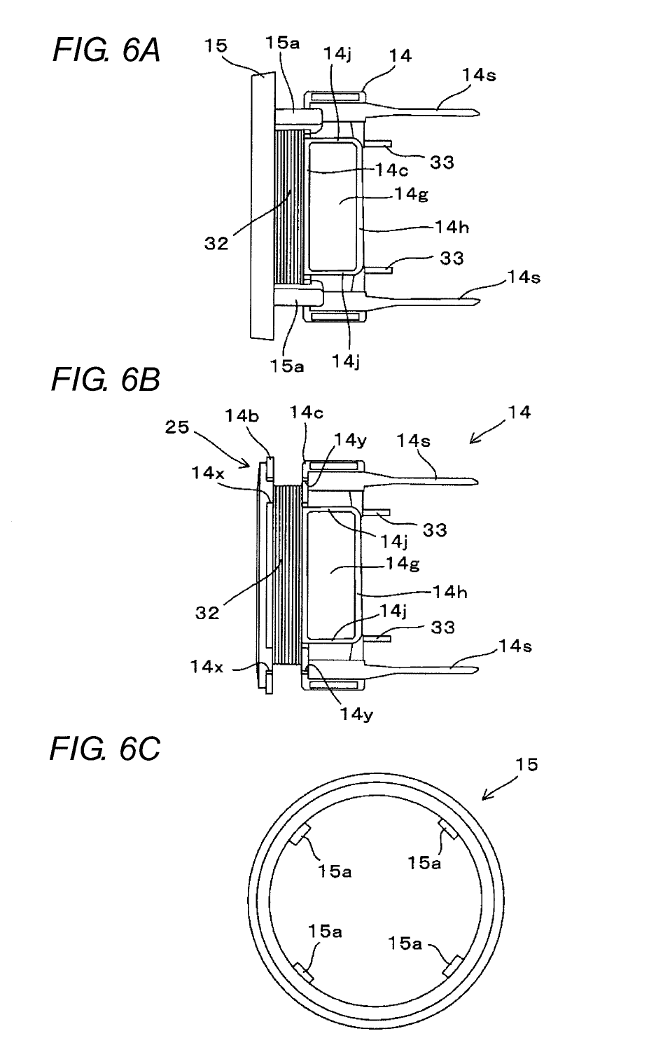

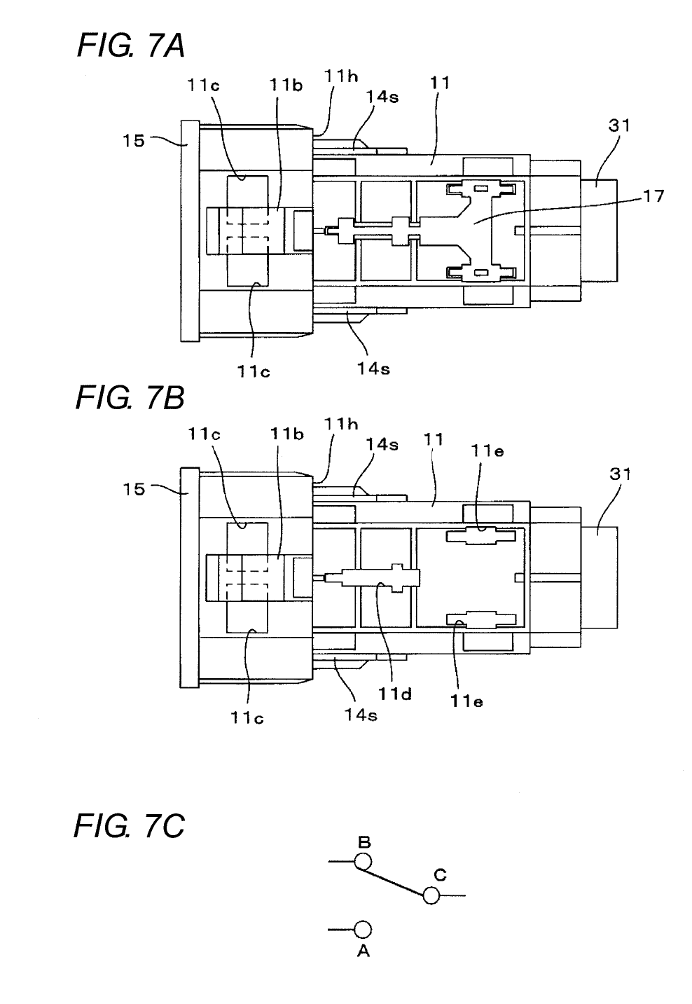

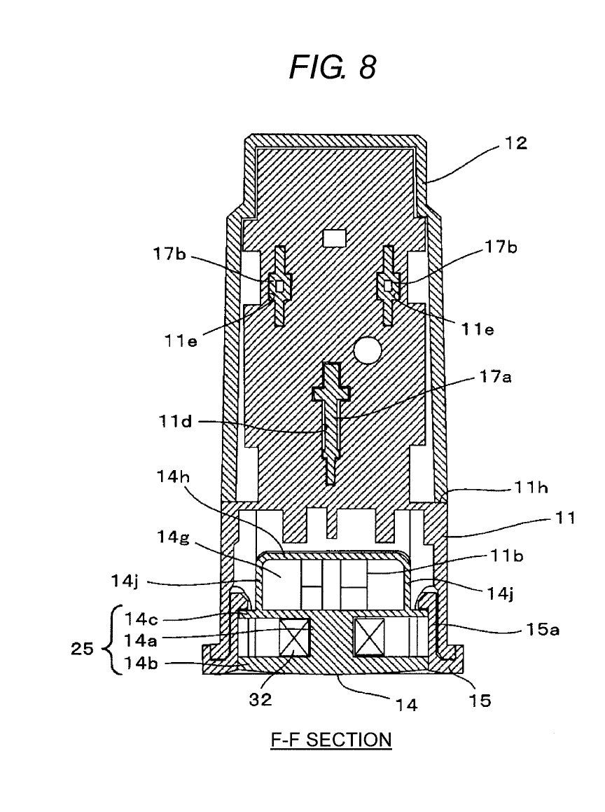

FIGS. 1A to 8 are views for describing a structure and components of a switch device 10 according to this embodiment. FIG. 1A is a front view of the switch device 10, and FIG. 1B is a horizontal sectional view (sectional view taken along line A-A of FIG. 1A). FIG. 2A is a horizontal sectional view of the switch device 10 (sectional view taken along line B-B of FIG. 1A), and FIG. 2B is a partial sectional side view of the switch device 10 (sectional view taken along line E of FIG. 1A). FIGS. 3 and 4 are sectional side views of the switch device 10 (sectional view taken along line C-C of FIG. 1A), FIG. 3 illustrates a neutral state (non-manipulated state), and FIG. 4 illustrates a full-stroke state (manipulated state in which a push button is pressed at a maximum). FIG. 5 is a sectional side view of the switch device 10 (sectional view taken along line D-D of FIG. 1A). FIGS. 6A and 6B illustrate a front-portion constituent member 14 (including a coil antenna 32) described below, where FIG. 6A is a bottom view illustrating a state in which a front-face circumferential member 15 is mounted on the front-portion constituent member 14, FIG. 6B is a bottom view illustrating a state in which the front-face circumferential member 15 is removed from the front-portion constituent member 14, and FIG. 6C is a front view of the front-face circumferential member 15. FIGS. 7A and 7B are bottom views of the switch device 10 in which a second case 12 is removed, where FIG. 7A illustrates a state in which a lower plate 17 is mounted, FIG. 7B illustrates a state in which the lower plate 17 is removed, and FIG. 7C illustrates a configuration example of a contact of switch bodies 41 and 42. FIG. 8 is a horizontal sectional view of the switch device 10 (sectional view taken along line F-F of FIG. 1A).

Hereinafter, a direction orthogonal to a paper plane in FIG. 1A is referred to as a front-back direction, a right-and-left direction in FIG. 1A is referred to as a horizontal direction, and an up-and-down direction in FIG. 1A is referred to as a vertical direction. Therefore, for example, the vertical direction in FIG. 1B becomes the front-back direction. Hereinafter, a downward direction in FIG. 1B is referred to as a front direction, and a leftward direction in FIG. 1B is referred to as a leftward direction.

As illustrated in FIG. 5, the switch device 10 is long and thin in the front-back direction as a whole, and the switch device 10 includes a first case 11, a second case 12, a push button 13, a front-portion constituent member 14, a front-face circumferential member 15, a slider 16, a lower plate 17, a return spring 18, a crisp feel spring 19, a crisp feel ball 20, a connector 31, a coil antenna 32, a circuit board 40, and switch bodies 41 and 42. In this case, the crisp feel spring 19 and the crisp feel spring 20 constitute a crisp feel generating mechanism 21.

In FIG. 1B, the switch device 10 is mounted on a panel wall P of the vehicle driver seat. As illustrated in FIG. 1B, the whole of the switch device 10 is substantially disposed inside the panel wall P while only a front surface side such as the push button 13 is exposed at the front.

The first case 11 is a molded component of synthetic resin, a bottom surface of the switch device 10 and a substantially lower half (mainly portion below a height of a circuit board 40) of a side face of the switch device 10 are covered with the first case 11, and an upper surface of the switch device 10 is opened. A lower half 11a of a flange (collar portion) is formed at a front end of the first case 11 in order to mount the front-face circumferential member 15. A latch piece 11b is formed in a front-side bottom surface of the first case 11 so as to be extended frontward, and the latch piece 11b is used for mounting the switch device 10 on the vehicle driver seat panel. Two drain ports 11c (see FIGS. 3, 7A and 7B) are provided on both sides in the horizontal direction of the latch piece 11b in a front-side bottom portion of the first case 11.

The drain port 11c is joined to and communicated with a drain 14g described below with no gap therebetween (see FIG. 2B). That is, a peripheral portion of the drain port 11c in the first case 11 and a wall (such as a drain rear wall portion 14h described below) surrounding the drain 14g are joined with no gap therebetween, only the inside of the lower end of the drain 14g can be visually recognized even if a person looks the inside of the switch device 10 through the drain port 11c from the outside of the switch device 10, and the person cannot visually recognize portions (particularly coil antenna 32, circuit board 40, and switch bodies 41 and 42) except for the inside of the lower end of the drain 14g.

An opening 11d is formed in a central bottom portion of the first case 11 in order that a ball contact portion 17a of the lower plate 17 is mounted from below and exposed to the inside (upward direction). Openings 11e (see FIG. 3) are formed on both sides in the horizontal direction of a back-side bottom portion of the first case 11 in order to pierce a stopper portion 17b of the lower plate 17 from below toward the inside (upward direction). A partition wall 11f, to which the front-end surface of the connector 31 is joined, is formed in the back-side bottom portion of the first case 11 so as to be extended upward. As illustrated in FIG. 5, a projection 11g is formed in a lower front face of the partition wall 11f, and the projection 11g is inserted in a back end of the return spring 18 to position the back end of the return spring 18. A step 11h is formed at a predetermined position (position on a back side of a base of the latch piece 11b) of an outer circumference of the first case 11 in order to join a lower portion of a front end face of the second case 12.

The return spring 18 and the slider 16, which are biasing members, are assembled inside the first case 11, and a guiding mechanism is provided between the slider 16 and the first case 11. The guiding mechanism has enough length to smoothly guide the slider 16 only in the front-back direction. In this embodiment, as illustrated in FIG. 1B, guide grooves 16m in the front-back direction are formed in side faces on both sides of a plate-like portion 16b (described below) of the slider 16 over the substantially total length of the plate-like portion 16b. On the other hand, in an internal surface of the first case 11 facing the plate-like portion 16b, guide projections 11t are provided at two positions in the front-back direction so as to be slidably fitted in the guide groove 16m, and the guide projections 11t and the guide grooves 16m constitute the guiding mechanism. Although not illustrated, a similar guiding mechanism is provided between the bottom surface of the slider 16 and the bottom surface of the first case 11.

As illustrated in FIG. 2B, a temporarily-jointing engagement projection 11k is formed at a relatively front side right position in the bottom portion of the first case 11. While the lower plate 17 is not mounted on the first case 11, the temporarily-jointing engagement projection 11k engages a temporarily-jointing engagement projection 16k (described below) of the slider 16 to prevent the slider 16 from moving in a return direction (in this case, the frontward direction) such that the slider 16 does not drop out from the first case 11 by a biasing force of the return spring 18.

The second case 12 is a synthetic resin molded product, and substantially the whole surface except for the front face of the switch device 10 is covered with the second case 12. The second case 12 is mounted such that the whole outer surface of the first case 11 except for the lower half of the portion in front of the step 11h is covered with the second case 12. The second case 12 is attached to the first case 11 by a latch portion (not illustrated) so as to be integral with the first case 11. As illustrated in FIG. 5, an upper half 12a of the flange is formed at a front end of the second case 12 in order to mount the front-face circumferential member 15. A latch piece 12b (the latch piece 12b and the latch piece 11b are disposed in pairs) is formed in a front-side bottom surface of the second case 12 so as to be extended frontward, and the latch piece 12b is used for mounting the switch device 10 on the vehicle driver seat panel. An opening 12c is formed in a back-end wall of the second case 12 in order to backwardly project a rear portion of the connector 31. As illustrated in FIG. 5, because the second case 12 is provided such that the bottom surface side of the lower plate 17 is covered with the second case 12 with a slight gap in an assembled state, the lower plate 17 cannot be removed as long as the second case 12 is removed. Therefore, the second case 12 also exerts a function of preventing the drop-out of the lower plate 17.

The push button 13 is a synthetic resin molded product, and the push button 13 is formed into a cap shape in which an inner cylindrical portion 13b and an outer cylindrical portion 13c are formed on a back side of a front-face wall 13a. The push button 13 is disposed inside the front-portion constituent member 14 and attached to a leading end of the slider 16, and the push button 13 is moved in the front-back direction while being integral with the slider 16. As illustrated in FIGS. 5 and 1A, the front-face wall 13a of the push button 13 is disposed while facing the center of the front surface of the switch device 10 such that a user (for example, vehicle driver) can press the push button 13 with a finger (that is, the front-face wall 13a of the push button 13 is disposed while facing the center of the opening on the front-end side of the case including the first case 11 and the second case 12). In the front-face wall 13a of the push button 13, characters are formed in the front face so as to clearly specify the button for starting (and stopping) the engine.

The front-portion constituent member 14 is a synthetic resin molded product, and the front-portion constituent member 14 includes an outer cylindrical portion 14a, a front wall portion 14b, a rear wall portion 14c, and an inner cylindrical portion 14d. The outer cylindrical portion 14a is disposed in concentric with the outer cylindrical portion 13c of the push button 13 along the outer circumference of the push button 13. The front wall portion 14b is formed into a collar shape so as to be radially extended outward from a front-end outer circumference of the outer cylindrical portion 14a. The rear wall portion 14c is formed into the collar shape so as to be radially extended from a back-end-side outer circumference of the outer cylindrical portion 14a. The inner cylindrical portion 14d is formed into a U-shape in section so as to be extended inward from the back end of the outer cylindrical portion 14a. As illustrated in FIGS. 6A and 6B, the front-portion constituent member 14 includes latch pieces 14s on both sides in the horizontal direction, and the latch piece 14s is formed so as to be extended backward from the side-portion back end of the outer cylindrical portion 14a. Leading-end sides of the latch pieces 14s are projected through the step 11h of the first case 11 (see FIG. 7A), and the leading-end sides of the latch pieces 14s are latched in a latch portion (not illustrated) formed at the back of the step 11h in the external surface of the first case 11, whereby the latch pieces 14s are integrally attached to the first case 11.

The portion from the position of the front wall portion 14b in the outer cylindrical portion 14a to the position of the rear wall portion 14c, the front wall portion 14b, and the rear wall portion 14c constitute a bobbin 25 around which a wire of a coil constituting the coil antenna 32 is wound.

The inner cylindrical portion 13b and outer cylindrical portion 13c of the push button 13 and the outer cylindrical portion 14a and inner cylindrical portion 14d of the front-portion constituent member 14 are concentrically disposed in relation to one center line in the front-back direction. In the radial direction in relation to the center line, the inner cylindrical portion 13b of the push button 13 is disposed inside the inner cylindrical portion 14d of the front-portion constituent member 14, the outer cylindrical portion 13c of the push button 13 is disposed between the outer cylindrical portion 14a and inner cylindrical portion 14d of the front-portion constituent member 14, and the push button 13 can be slid in the front-back direction with respect to the front-portion constituent member 14.

The leading end of the inner cylindrical portion 14d of the front-portion constituent member 14 is formed so as to be extended frontward along the outer cylindrical portion 14a. As illustrated in FIG. 4, when the push button 13 is pushed down, the leading end of the inner cylindrical portion 14d invades between the inner cylindrical portion 13b and outer cylindrical portion 13c of the push button 13.

As illustrated in FIG. 3, in the assembled state, the outer circumference of the bobbin 25 is covered with the first case 11 and second case 12 with no gap therebetween, the coil antenna 32 is disposed in a basically closed space (that is, a space surrounded by the first case 11, the second case 12, and the outer cylindrical portion 14a, front wall portion 14b, and rear wall portion 14c of the front-portion constituent member 14) with the exception of a coil wire lead groove 14f (described below) and the like.

A coil terminal support portions 14e (see FIG. 2A) are formed on both sides in the horizontal direction at the back end of the front-portion constituent member 14 so as to be projected backward. A metal coil terminal 33 is fixed to the coil terminal support portion 14e by insert molding. One end of the coil terminal 33 is extended upward from the coil terminal support portion 14e and connected to the circuit board 40, and the other end is extended backward from the coil terminal support portion 14e and connected to the coil antenna 32. The coil terminal 33 as a whole has an L-shape when viewed from the side face. The wire of the coil constituting the coil antenna 32 is wound around the bobbin 25, that is, the outer circumference (between the front wall portion 14b and the rear wall portion 14c) of the outer cylindrical portion 14a of the front-portion constituent member 14. Each end (not illustrated) of the wire of the coil constituting the coil antenna 32 is led out from the bobbin 25 through the coil wire lead grooves 14f (indicated by a dotted line of FIG. 2A) formed in both side portions at the back end of the front-portion constituent member 14, and the end (not illustrated) of the wire is connected to the other end of each of the coil terminals 33 at both ends in the horizontal direction. One end (upper end) of the coil terminal 33 is inserted in a predetermined through-hole of the circuit board 40 and connected to a predetermined circuit conductor of the circuit board 40 by soldering.

As illustrated in FIGS. 2B, 6A, and 6B, the drain 14g in the substantially vertical direction is formed in the lower portion at the back end of the front-portion constituent member 14. The drain 14g is used to cause a liquid (such as rain water and juice) invading from the gap between the outer cylindrical portion 13c of the push button 13 and the outer cylindrical portion 14a of the front-portion constituent member 14 to flow down the lower portion on the rear side of the bobbin 25 through the inside of the bobbin 25 to drain away the liquid. The whole of the lower-end side of the drain 14g is surrounded with no gap by the lower-end portion of the rear wall portion 14c, a drain rear wall portion 14h extended downward from the lower portion at the back end of the inner cylindrical portion 14d, and a drain sidewall portion 14j (see FIGS. 6A and 6B) extended backward from both sides at the lower end of the rear wall portion 14c. The lower-end side of the drain 14g is separated from the region (between the front wall portion 14b and the rear wall portion 14c, that is, the inside of the bobbin 25) where the coil antenna 32 is disposed. As illustrated in FIGS. 3 and 2B, the upper-end side of the drain 14g is formed so as to pierce through a back-end-side coupling portion between the outer cylindrical portion 14a and the inner cylindrical portion 14d, the upper-end side of the drain 14g is communicated with a lower portion of a space between the outer cylindrical portion 14a and the inner cylindrical portion 14d, the water invading in the upper-end side of the drain 14g flows down to the drain 14g as illustrated by an arrow in FIG. 2B. That is, as illustrated in FIG. 2B, the upper surface of the upper-end portion of the drain 14g is covered with the lower portion of the inner cylindrical portion 14d of the front-portion constituent member 14, and the upper-end portion of the drain 14g is curved frontward and communicated with the inside of the bobbin 25.

As described above, as illustrated in FIGS. 2B, 7A, and 7B, the lower-end side of the drain 14g is joined to and communicated with the drain ports 11c that are formed in parallel in the lower portion of the first case 11 with no gap therebetween, the liquid flowing down to the drain 14g falls down to the lower portion of the switch device 10 and drained away from one of the drain ports 11c.

Accordingly, only the inner surface of each wall (the rear wall portion 14c, the drain rear wall portion 14h, the drain sidewall portion 14j, and the inner cylindrical portion 14d) surrounding the lower-end portion of the drain 14g can be visually recognized even if the person looks inside of the switch device 10 through the drain port 11c or the lower-end opening of the drain 14g, and the portion (the coil antenna 32, the coil terminal 33, the circuit board 40, and the switch bodies 41 and 42 in which the switch contact is incorporated) that is important from the viewpoint of security cannot be visually recognized from the drain port 11c or the lower-end opening of the drain 14g.

The front-face circumferential member 15 is a synthetic resin molded product, and the front-face circumferential member 15 is a ring member that decorates the outer circumference in the front surface of the switch device 10 (see FIG. 6C). The front-face circumferential member 15 is mounted such that the outer circumferential portion of the front wall portion 14b of the front-portion constituent member 14 and a front face and an outer circumferential surface of the flanges 11a and 12a formed in the outer circumferences at front ends of the first case 11 and second case 12 are covered with the front-face circumferential member 15. As illustrated in FIGS. 6A and 6C, the front-face circumferential member 15 includes latch pieces 15a at four points in the circumferential direction, and the latch pieces 15a are extended backward from the rear-face side. In the front-face circumferential member 15, as illustrated in FIG. 6A, a pawl (reference numeral is not given) formed toward the leading end of each latch piece 15a engages a rear-surface-side of the rear wall portion 14c of the front-portion constituent member 14. Therefore, the front-face circumferential member 15 is attached to the outer circumference of the front wall portion 14b or rear wall portion 14c of the front-portion constituent member 14, and the front-face circumferential member 15 is integral with the front-portion constituent member 14. In FIG. 6B, notches 14x and 14y are formed in the outer circumference of the front wall portion 14b or rear wall portion 14c of the front-portion constituent member 14 in order to fit the latch pieces 15a therein. As illustrated in FIGS. 6A and 6C, the latch pieces 15a and the notches 14x and 14y are disposed at positions that are different from the drain 14g in the circumferential direction. Therefore, the notches 14x and 14y are formed in a peripheral edge at the lower end of the drain 14g to prevent the generation of the gap through which the coil antenna 32 and the like can be visually recognized from the outside through the drain port 11c.

The slider 16 is a synthetic resin molded product, and the slider 16 includes a cylindrical portion 16a and a plate-like portion 16b. The front-end portion of the cylindrical portion 16a is mounted in the inner cylindrical portion 13b of the push button 13. The plate-like portion 16b is formed so as to be extended backward from the lower portion at the back end of the cylindrical portion 16a. As illustrated in FIG. 1B, the plate-like portion 16b of the slider 16 has a rectangular outer shape as a whole when viewed from the upper surface, and the plate-like portion 16b of the slider 16 is mounted on the bottom surface of the first case 11 while being slidable in the front-back direction with respect to the first case 11.

Stopper openings 16c are formed on both sides in the horizontal direction in the back-end portion of the plate-like portion 16b of the slider 16 while piercing vertically through the back-end portion of the plate-like portion 16b. An upper-end portion of a stopper portion 17b of the lower plate 17 is inserted in the stopper opening 16c. In the assembled state of the switch device 10, a range where the slider 16 and the push button 13 integrated therewith move in the front-back direction is controlled within a predetermined range by abutment between inner end faces in the front-back direction of the stopper opening 16c and the upper-end portion of the stopper portion 17b. The predetermined range means a range from the position of the neutral state (non-manipulated state) of FIG. 3 to the position in the full-stroke state of FIG. 4.

Inclined surfaces 35 and 36 are formed at positions (position in front of the stopper opening 16c on the left side) on the left side in the upper surface of the plate-like portion 16b. The inclined surfaces 35 and 36 are inclined with respect to a predetermined direction (in this case, the front-back direction) in which the slider 16 moves, and the inclined surfaces 35 and 36 can come into contact with pressing manipulation portions 41a and 42a described below (see FIG. 3). The inclined surface 35 and 36 are formed in parallel in the front-back direction, the front-side inclined surface 35 comes into contact with the pressing manipulation portion 41a of the front-side switch body 41, and the back-side inclined surface 36 comes into contact with the pressing manipulation portion 42b of the back-side switch body 42. In this case, the inclined surface 35 is downwardly inclined in the backward direction, and the inclined surface 35 has a positively inclined surface inclined toward an orientation in which the pressing manipulation portion 41a retreats in activating the switch device 10. On the other hand, the inclined surface 36 is upwardly inclined in the backward direction, and the inclined surface 36 has a reversely inclined surface inclined toward an orientation in which the pressing manipulation portion 42a advances in activating the switch device 10.

As illustrated in FIGS. 1B and 5, a recessed chamber 16d in which the return spring 18 is disposed is formed on the bottom surface side at a central position in the horizontal direction in the back-end portion of the plate-like portion 16b of the slider 16. A projection 16e (see FIG. 5, neglected in FIG. 1) projected backward is formed in the inner end face in front of the recessed chamber 16d. The leading-end portion of the return spring 18 is mounted on the outer circumference of the projection 16e, whereby the leading-end portion of the return spring 18 is positioned and retained.

As illustrated in FIG. 5, a boss 16f projected upward is formed at the central position in the horizontal direction on the relatively front side of the plate-like portion 16b of the slider 16. As illustrated in FIG. 5, a cylindrical recessed chamber 16g opened onto the bottom surface side is formed in the boss 16f, and a crisp feel spring 19 and a crisp feel ball 20 are sequentially loaded in the cylindrical recessed chamber 16g.

As described above, the guide grooves 16m are formed in the side faces on both sides of the plate-like portion 16b of the slider 16 over the substantially total length of the plate-like portion 16b (see FIG. 1B), the guide projections 11t that are slidably fitted in the guide grooves 16m are provided at the two positions in the front-back direction in the internal surface of the first case 11, and the guide projection 11t and the guide groove 16m constitute the guiding mechanism. Although not illustrated, the similar guiding mechanism is provided between the bottom surface of the slider 16 and the bottom surface of the first case 11. In this case, the back end of the guide groove 16m is obviously opened backward such that the slider 16 can be mounted therein.

After the return spring 18 is mounted on the slider 16, the slider 16 is inserted in a pressing manipulation direction (the right in FIG. 5) against the biasing force of the return spring 18 and mounted in the first case 11, while the guide projection 11t corresponding to each guide groove 16m is fitted from the front side (left side in FIG. 5) of the first case 11. Therefore, the slider 16 is assembled in the first case 11 while being movable only in the front-back direction.

In order to avoid interference with the stopper portion 17b of the lower plate 17, the slider 16 is mounted on the first case 11 with the above-described assembly structure before the lower plate 17 is mounted on the first case 11.

As illustrated in FIG. 2B, the temporarily-jointing engagement projection 16k that can engage with the temporarily-jointing engagement projection 11k is formed at a relatively right-front-side position in the bottom surface of the plate-like portion 16b of the slider 16.

However, when the slider 16 is assembled in the first case 1, the temporarily-jointing engagement projection 11k and the temporarily-jointing engagement projection 16k elastically deform so as not to engage each other, which allows the slider 16 to be assembled in the above-described manner. Therefore, in the temporarily-jointing engagement projection 11k and the temporarily-jointing engagement projection 16k, the surfaces that come into contact with each other in assembling the slider 16 become the inclined surfaces as illustrated in FIG. 2B, and the surfaces become the small projections that can cross over each other with a slight deformation (including a deformation of each projection and deflection of surrounding portion) in assembling the slider 16.

The lower plate 17 is a synthetic resin molded product. As illustrated in FIGS. 5, 7A and 7B, the lower plate 17 is mounted from below on the bottom surface of the first case 11 so as to be integral with the first case 11. Only the lower plate 17 is detachably attached to the first case 11 while the return spring 18 and the slider 16 are assembled in the first case 11 (however, the second case 12 is detached). As illustrated in FIG. 7A, when the lower plate 17 is viewed from the bottom surface, the central portion in the horizontal direction of the lower plate 17 is elongated frontward, and the back-end portion of the lower plate 17 is horizontally extended, and the lower plate 17 has a substantial T-outer-shape as a whole. The upper surface side in the frontward-extended front-end portion of the lower plate 17 is fitted in the opening 11d of the first case 11, and the upper surface comes into contact with the crisp feel ball 20, thereby constituting the ball contact portion 17a. As illustrated in FIGS. 3 and 8, the stopper portions 17b are formed at both ends in the horizontal direction at two positions of the back-end portion of the lower plate 17, and each stopper portion 17b is fitted in the opening 11e of the first case 11.

The stopper portions 17b constitute the stopper that controls a movement range of the slider 16, and the stopper portions 17b are projected upward from both ends in the horizontal direction of the back-end portion of the lower plate 17 and inserted in the stopper openings 16c formed in the slider 16. When the slider 16 is located at a non-manipulated position, the stopper portion 17b abut on the inner end face on the back side of the stopper opening 16c, and the stopper portion 17b engages the slider 16, thereby preventing the slider 16 from moving in the return direction (in this case, frontward direction) beyond the non-manipulated position. In this embodiment, the stopper portion 17b also controls the stroke in the pressing manipulation direction (in this case, backward direction) of the slider 16. That is, in the full-stroke state in which the push button 13 is pushed down to backwardly move the slider 16 to the full stroke, as illustrated in FIG. 4, the stopper portion 17b abuts on the inner end face on the front side of the stopper opening 16c, and the stopper portion 17b engages the slider 16, thereby preventing the slider 16 from moving in the pressing manipulation direction (in this case, the backward direction) beyond the position of the full-stroke state.

As described above, the return spring 18 is the coil spring mounted between the rear portion of the slider 16 and the partition wall 11f of the first case 11, and the return spring 18 acts as the biasing member that biases the slider 16 toward the non-manipulated position (in this case, frontward direction).

The crisp feel generating mechanism 21 includes the crisp feel spring 19, the crisp feel ball 20, and a ball contact portion 17a. The crisp feel ball 20 is always pushed downward by the biasing force of the crisp feel spring 19, and the crisp feel ball 20 is pressed against the upper surface of the ball contact portion 17a. The crisp feel ball 20 moves in the front-back direction along with the slider 16, while the ball contact portion 17a integral with the first case 11 does not move in the front-back direction. The upper surface of the ball contact portion 17a is raised into a substantial chevron shape, and the crisp feel ball 20 is in press contact with a position slightly in front of an apex position raised in the upper surface of the ball contact portion 17a in the neutral state in which the push button 13 or the slider 16 is located at the non-manipulated position (see FIGS. 3 and 5). In the activated state in which the slider 16 moves from the non-manipulated position beyond a predetermined activated position (for example, a position at which the slider 16 is pushed down by 1.2 mm from the non-manipulated position), it is necessary that the crisp feel ball 20 crosses over the apex position of the ball contact portion 17a while compressing the crisp feel spring 19. In this case, a resistance force is generated in the slider 16 by compressing the crisp feel spring 19, and the resistance force generates a crisp feel. The shape of the upper surface of the ball contact portion 17a is set such that magnitude of the resistance force becomes a peak (maximum) at the position slightly in front of the activated position (for example, the position at which the slider 16 is pushed down by 1.0 mm from the non-manipulated position).

The connector 31 electrically connects the switch device 10 and an external device (for example, a vehicle engine controller or an in-vehicle controller for immobilizer). The connector 31 and the predetermined circuit conductor of the circuit board 40 are connected by L-shape terminals 31a and 31b of FIG. 5. The L-shape terminals 31a and 31b are extended from the front end of the connector 31, and leading ends of the L-shape terminals 31a and 31b are soldered while inserted in the through-holes of the circuit board 40.

As described above, the coil antenna 32 is formed by winding the coil wire (lead whose surface is covered with insulating material) around the outer circumference (between the front wall portion 14b and the rear wall portion 14c) of the outer cylindrical portion 14a of the front-portion constituent member 14. The coil antenna 32 is connected to the predetermined circuit conductor of the circuit board 40 through the coil terminal 33. The coil antenna 32 is used as an emergency antenna when the normal wireless communication for verification cannot be conducted between the electronic key and the antenna of the in-vehicle controller for immobilizer due to the consumed battery for the immobilizer electronic key. When the user brings the electronic key close to the push button 13 (that is, close to the coil antenna 32), the coil antenna 32 is operated by electric power transfer of an electromagnetic wave transmitted from the coil antenna 32, and the wireless communication for verification is conducted between the electronic key and the coil antenna 32. When the verification result is affirmative, the starting of the engine is permitted.

The switch bodies 41 and 42 and the like are mounted on the circuit board 40. A drive circuit of the coil antenna 32 may be formed on the circuit board 40. The circuit board 40 is disposed so as to close the upper surface of the first case 11 while a board surface is parallel to the front-back direction and orthogonal to the vertical direction. The circuit board 40 is fixed to the first case 11 and the connector 31 by a latch portion (not illustrated) or a screw.

In FIG. 5, a light-emitting portion 37 is formed by a light-emitting element mounted on the bottom surface side in the front portion of the circuit board 40. The light-emitting portion 37 emits light to the push button 13 from the backside to illuminate the push button 13, thereby notifying the user of the position of the push button 13.

The switch bodies 41 and 42 are module type switches, and the switch bodies 41 and 42 are, for example, so-called detection switch (or micro switch). The switch bodies 41 and 42 include pressing manipulation portions 41a and 42a (see FIG. 3), respectively. The pressing manipulation portions 41a and 42a can move in retreating and advancing directions so as to emerge and disappear, and the pressing manipulation portions 41a and 42a are biased in a forward direction (in this case, downwardly-projected direction). Switch contacts are incorporated in the switch bodies 41 and 42, and on and off states of the switch contact are switched by the retreating and advancing movements of each of the pressing manipulation portions 41a and 42a. As illustrated in FIG. 7C, for example, the switch bodies 41 and 42 include contact terminals A, B, and C, the switch bodies 41 and 42 become a non-activated state in which the electric conduction is established between the common terminal C and the normally closed terminal B when the pressing manipulation portions 41a and 42a are not pushed down, and the switch bodies 41 and 42 become an activated state in which the electric conduction is established between the common terminal C and the normally closed terminal A when the pressing manipulation portions 41a and 42a are pushed down to at least a predetermined amount. In this case, the vehicle engine starting controller and the like connected to the switch device 10 through the connector 31 reads the switching operation of the contacts of the switch bodies 41 and 42 to determine that an instruction of starting or stopping the engine is provided.

As illustrated in FIG. 3, the switch bodies 41 and 42 are mounted on the bottom surface side of the circuit board 40, and the switch bodies 41 and 42 are placed such that the retreating and advancing directions of each of the pressing manipulation portions 41a and 42a intersect the front-back direction.

In the neutral state in which the push button 13 or the slider 16 is located at the non-manipulated position (see FIG. 3), the pressing manipulation portion 41a of the switch body 41 becomes a state in which the pressing manipulation portion 41a advances at a maximum while not being in press contact with the inclined surface 35 (that is, the pressing manipulation portion 41a advances downward at a maximum, and the contact is in the non-activated state). When the push button 13 or the slider 16 is further pushed down to the back of the non-manipulated position, the pressing manipulation portion 41a comes into press contact with the inclined surface 35 to start the retreating operation (that is, upwardly-pushed operation is started). When the push button 13 or the slider 16 is pushed down to the activated state, the pressing manipulation portion 41a retreats to the position at which the state of the contact of the switch body 41 is switched from the non-activated state to the activated state.

In the neutral state, the pressing manipulation portion 42a of the switch body 42 becomes a state in which the pressing manipulation portion 42a comes into press contact with the inclined surface 36 to retreat at a maximum (that is, pushed down at a maximum, and the contact is in the activated state). When the push button 13 or the slider 16 is pushed down at the back of the non-manipulated position, the pressing manipulation portion 42a comes into press contact with the inclined surface 36 to start the advancing operation (that is, downwardly-projected advancing operation is started). When the push button 13 or the slider 16 is pushed down to the activated state, the pressing manipulation portion 42a advances to the position at which the state of the contact of the switch body 42 is switched from the activated state to the non-activated state.

In the switch device 10, in the neutral state in which the user does not press the push button 13, the slider 16 of FIG. 3 is retained at the non-manipulated position (position at which the upper-end portion of the stopper portion 17b abuts on the end face on the back side of the stopper opening 16c) by the biasing force of the return spring 18. Therefore, because the switch body 41 is in the non-activated state while the switch body 42 is in the activated state, the instruction of starting or stopping the vehicle engine is not provided (that is, the controller side does not determine that the instruction of starting or stopping the vehicle engine is provided).

When the user performs the manipulation for backwardly pushing down the push button 13 against the biasing force of the return spring 18 or the resistance force of the crisp feel generating mechanism 21 to push down the push button 13 or the slider 16 at the back of the activated position, the inclined surface 35 and 36 come into contact with the pressing manipulation portions 41a and 42a of the switch bodies 41 and 42 to move the pressing manipulation portions 41a and 42a in the advancing and retreating directions, thereby switching the on and off states of the switch contacts of the switch bodies 41 and 42 (in this case, the switch body 41 becomes the activated state while the switch body 42 becomes the non-activated state). Therefore, the instruction of starting or stopping the vehicle engine is provided (that is, the controller side determines that the instruction of starting or stopping the vehicle engine is provided).

When the user performs the manipulation for backwardly pushing down push button 13, usually the push button 13 or the slider 16 moves tentatively to the full stroke state. In the full-stroke state, the upper-end portion of the stopper portion 17b abuts on the inner end face on the front side of the stopper opening 16c to prevent the push button 13 or the slider 16 from moving backward.

The in-vehicle controller side may determine the instruction based on an AND condition of the operations of the contacts of the switch bodies 41 and 42 or an OR condition. That is, the in-vehicle controller side may determine that the instruction is provided when both the states of the contacts of the switch bodies 41 and 42 (specifically, the state of a signal such as a voltage corresponding to the state of the contact) are properly changed, or the in-vehicle controller side may determine that the instruction is provided when one of the states of the contacts of the switch bodies 41 and 42 is properly changed. However, in order that the instruction of the vehicle engine starting is securely provided even if one of the switch bodies 41 and 42 breaks down, desirably the in-vehicle controller side determines that the instruction is provided when one of the states of the contacts of the switch bodies 41 and 42 is properly changed (that is, the contact of the switch body 41 is changed from the non-activated state to the activated state, or the contact of the switch body 42 is changed from the activated state to the non-activated state).

Thus, in the switch device 10, the instruction of starting or stopping the engine can be provided with high reliability by the switch bodies 41 and 42.

Further, in the switch device 10 of this embodiment, the coil bobbin 25 is formed in the outer circumference of the front-portion constituent member 14, the drain 14g is formed in the front-portion constituent member 14 in order that the liquid invading from the gap between the outer circumference of the push button 13 and the front-portion constituent member 14 is caused to flow down to the lower portion on the rear side of the bobbin 25 through the inside of the bobbin 25, and the drain port 11c is formed on the bottom surface side of the case (first case 11) while connected to the lower-end opening of the drain 14g with no gap therebetween. Therefore, because the switch device 10 has the structure in which at least the coil 32 cannot be visually recognized from the drain port 11c, the security degradation caused by visually recognizing the coil 32 from the outside of the switch device 10 can be avoided while the drain property of the liquid invading from the gap of the outer circumference of the push button 13 is maintained. In switch device 10, the circuit board 40 is provided in the case (including the first case 11 and the second case 12), the switch contacts are incorporated in the switch bodies 41 and 42, and the coil 32 is connected to the circuit board 40. The circuit board 40 and the switch bodies 41 and 42 (including the switch contacts) cannot be visually recognized from the drain port 11c. Therefore, the security degradation caused by visually recognizing the circuit board 40 or the switch contact from the outside of the switch device 10 can be avoided.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A switch device comprising:
a slider that advances and retreats in a front-back direction;
a push button that is integrally provided at a front end of the slider;
a switch contact whose on and off states are switched according to an operation for pushing down the push button to cause the slider to retreat;
a biasing member that biases the slider in an advancing direction in order to return the push button and the slider to a non-manipulated position;
a case in which the switch contact, the biasing member, and the slider are assembled, the push button being disposed in an opening at a front end of the case;
a front-portion constituent member that is attached to the case while disposed around the push button in the opening; and
a coil that is wound around a bobbin formed in an outer circumference of the front-portion constituent member,
wherein a drain that causes a liquid to flow down to a lower portion on a rear side of the bobbin through an inside of the bobbin is formed in the front-portion constituent member, the liquid invading from a gap between an outer circumference of the push button and the front-portion constituent member, and
a drain port that is joined to and communicated with a lower-end opening of the drain with no gap therebetween is formed on a bottom surface side of the case, and at least the coil cannot be visually recognized from the drain port.

2. The switch device according to claim 1, wherein a circuit board to which the switch contact and the coil are connected is provided in the case, and the circuit board and the switch contact cannot be visually recognized from the drain port.
